(19) United States
(12) Patent Application Publication
(10) Pub. No.: US 2009/0093970 A1
(43) Pub. Date: Apr. 9, 2009

(54) Automated Sampling And Analysis Using A Personal Sampler Device

(76) Inventors: Hadas Lewy, Tel Aviv (IL); Noam Asna, Tel Aviv (IL); Doron Levi, Ramat Gan (IL)

Correspondence Address: The Law Office of Michael E. Kondoudis, PC, 888 16th Street, N.W., Suite 800, Washington, DC, 20006, US

(21) Appl. No.: 12/282,120

(22) PCT Filed: Mar. 5, 2007
(86) PCT No.: PCT/IL2007/000276

§ 371 Date: Sep. 8, 2008

Related U.S. Application Data
(60) Provisional application No. 60/780,943, filed on Mar. 10, 2006.

(51) Int. Cl. G06F 19/00; G01N 1/31; G06K 9/00

(52) U.S. Cl. 702/21; 702/19; 435/309.1; 382/128

(57) ABSTRACT

The present invention is a system and a method for blood or urine sampling and sample-analysis, through a sampler that is a self blood-testing device or a urine-testing device. The system comprises a sampler, a transmission unit and an analysis unit. A patient may place a sampled blood drops on a sample strip and insert the strip into the sampler. The sampler may automatically prepare the sample and photograph it using a sample-preparation unit and a photography unit respectively. After the sample has been photographed, the resulting sample image may be transmitted to the analysis unit that may analyze the image through an image-processing algorithm. The analysis results may be automatically transmitted to the patient and to a medical authority, such as the patient's physician, a nurse, a clinic and the like, for further analysis, decision-making and treatment.

### FIELD OF THE INVENTION

The present invention generally relates to the field of medical systems. More particularly, the present invention relates to the field of sampling systems and automated sampling analysis.

### BACKGROUND OF TEE INVENTION

The most common side effect of chemotherapy treatment is bone marrow suppression. The treatment induces a decrease in neutrophils (an abundant type of granular white blood cells) count and thus become the rate-limiting factor in chemotherapy treatment. Maintaining neutrophils level within a normal range is mandatory for the success of the treatment and for avoiding lethal toxicity. Therefore, blood count tests are a routine procedure for cancer patients, for example, properly and safely maintaining their treatment schedule.

Blood counts and blood components tests are presently made only in certified laboratories either by venous sampling or by drawing peripheral blood. On a daily basis, a blood count may be an inconvenient activity for patients, such as cancer patients and the like. The necessity, to go to the lab, on a daily basis, where a member of the medical personnel, such as a physician or a nurse, has to find the right venous access that causes physical pain, loss of working days, loss of money and time for the patient as well as for the insurance system.

A patent number US2005130236, by Goldman Richard M. discloses a home health care blood chemistry apparatus that requires only a “pin prick” sample of a patient's capillary blood. The sample is applied to a test strip including a sample receiving pad and sample analysis pads. The blood sample is applied to the sample receiving pad and flows, by surface tension, and capillary flow to the separate analysis pads that are in parallel with each other and in series with the sample-receiving pad. Each sample pad contains reagents that are specific to producing an optically detectable effect for a specific blood component. The optical effects are detected by a reflectance meter that is used in conjunction with the test strip. The optical effects are converted to digital data, and stored in a storage device associated with the meter, for transmission to a health care.

A patent number JP60162955 by Matsushita Hajime, Shinudou Isao and Yabe Riyouhei discloses an automatic analysis device for blood cells. A blood from a patient is smeared on slide glass and is dyed to prepare a dye specimen. The blood cells on the specimen are magnified by an optical microscope and taken as a three-color image by a camera. The image is digitally stored. The specific quantity of the blood cells is calculated from the blood cell image. The white blood cells, red blood cells and platelets are analyzed and detected by an automatic blood cell classifying system.

Goldman and Matsushita do not disclose a method or a system that provides automated and computerized analysis of the data stored by the reflectance meter or the microscope. Furthermore, Goldman and Matsushita do not discuss as for how the results of the data analysis are transmitted or received and by whom.

### SUMMARY OF THE INVENTION

The present invention is a system and a method for blood sampling and sample-analysis that is suited for blood counts or for blood components tests of various types of blood cells and blood components. According to some embodiments of the present invention, the present invention may further suit analysis of urine samples.

The system comprises a sampler device, sampler preparation unit, a transmission unit and an analysis unit. A patient may take a self blood-sample by pin pricking his finger, for example, and place the sampled blood drops on a sample strip. The patient may then insert the strip into the sampler. The sampler may chemically prepare the sample and photograph it using a photography unit that includes a camera that is installed in the sampler. After the sample has been photographed, the resulting sample image may be transmitted to the analysis unit that may analyze the image through an image-processing algorithm. The analysis results may be automatically transmitted to the patient and to a medical authority, such as the patient's physician, a nurse, a clinic and the like, for further medical analysis, decision-making and treatment.

According to embodiments of the present invention, the photography unit may include a digital camera, a solid-state detector and like, without requiring photography by a microscope.

The sampler that is a self blood-testing device may include a housing unit—for placing and holding the sample strip, a sample-preparation unit—for preparing the sample to be photographed, a photography unit—to photograph the sample and allow digital storage of the sample image. The sampler may further include a connector that may allow connection to a communication network and a power connection to allow connection to a power source. The sample-preparation unit prepares the sample by an automated or a manual process that includes smearing, drying and staining the sample.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a system for blood sampling and sample-analysis, according to some embodiments of the present invention.

FIG. 2 is a schematic illustration of a sampler, according to some embodiments of the present invention.

FIG. 3 is a schematic illustration of a smearing device that is installed within the sampler, according to some embodiments of the present invention.

FIG. 4 is a schematic flow diagram of a method for blood sampling and sample-analysis, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention is a system and a method for blood or urine sampling and sample-analysis. The system comprises a sampler 100 device, a transmission unit 500 and an analysis unit 200. Patient 10 may take a self blood-sample by pin pricking his finger, for example, and place the sampled blood drops on a sample strip 115. Patient 10 may then insert strip 115 into sampler 100. Sampler 100 may chemically and mechanically prepare the sample and photograph the sample using a photography unit 120. After the sample has been photographed, the sample image may be transmitted to analysis unit 200, where the results of the image analysis may be automatically transmitted to patient 10 and to a medical authority 20 for further analysis, decision-making and treatment.

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

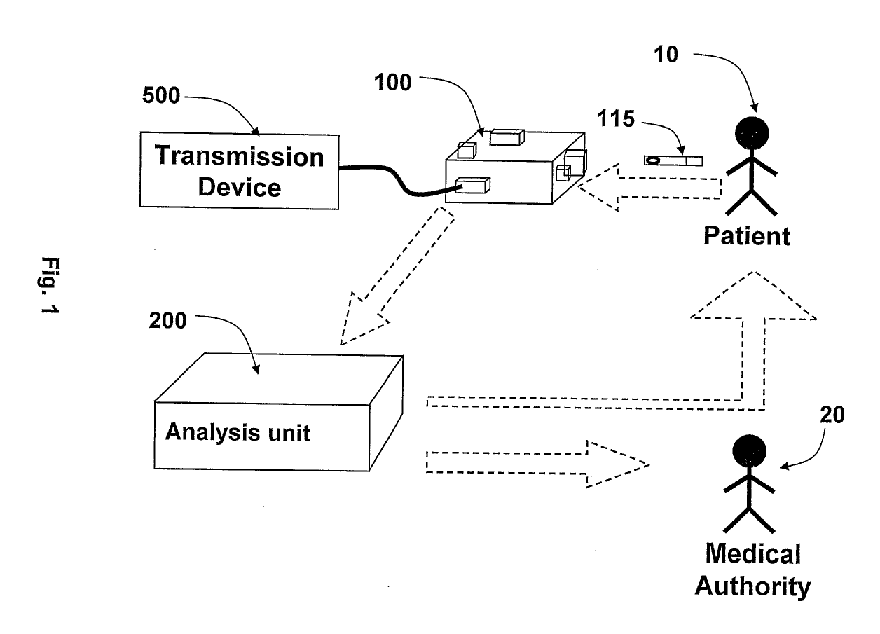

FIG. 1 schematically illustrates a system for blood sampling and sample-analysis, according to some embodiments of the present invention. The system comprises sampler 100, transmission unit 500, and analysis unit 200. Patient 10 may place the sampled blood drops or urine drops on a sample strip 115 and inserts sample strip 115 into sampler 100. Sampler 100 may chemically and mechanically prepare the sample; photograph the prepared sample and transmit the photographed sample image along with patient's 10 related information to analysis unit 200. Analysis unit 200 may then analyze the sample image using computerized software algorithms and output the results of the analysis as “results” data. Analysis unit 200 may transmit the results to patient 10 and to a medical authority 20 such as the patient's 10 physician, a nurse, a clinic and the like. Medical authority 20 may use those results for supervising patient's 10 physical condition on daily basis, for example and for deciding upon further treatment.

According to embodiments of the present invention, the sample image and patient's 10 related information may be stored and transmitted as digital data by sampler 100 and by analysis unit 200. Patient's 10 related information may be patient's 10 personal details such as name, identification number, date of birth, medical history and the like. Patient's 10 related information may also include information relating to the details of transmission of data such as date and time of transmission, validation of transmission and receiving of data and the like.

According to embodiments of the present invention, to produce the blood drops for the sampling, patient 10 may be required to pin prick his finger, using a needle or any other pricking device. The pricking devices as well as sample strips 115 may be attached to sampler 100 when purchasing sampler 100 and may further be accessible as a separate unit.

According to embodiments of the present invention, transmission unit 500 may be any device that enables network communication and transmission of data, as long sampler 100 enables connection with transmission unit 500. Transmission unit 500 may also be an integrated part of sampler 100 where the sample image photographed by sampler 100 is automatically transmitted to analysis unit 200.

According to embodiments of the present invention, transmission unit may be a network device such as a cellular phone, a computer, a laptop and the like.

According to embodiments of the present invention, analysis unit 200 may be any network device that allows computation such as a computer, a processing chip attached to a cellular phone or to sampler 100, a laptop and the like. The analysis may be carried out through at least one software application installed within analysis unit 200, where the application may include image processing. According to other embodiment of the present invention, the analysis and image processing may be carried out through hardware such as a processor chip and the like.

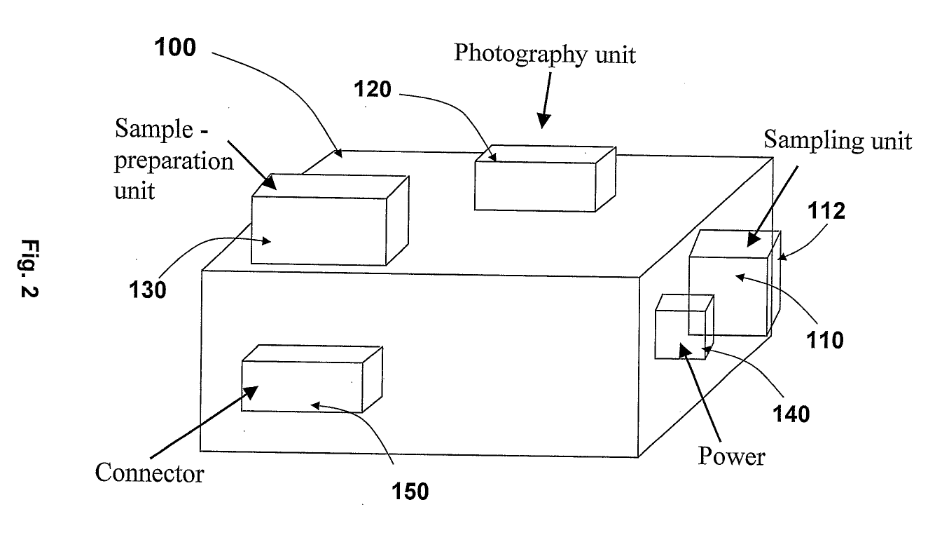

FIG. 2 schematically illustrates sampler 100, according to some embodiments of the present invention. Sampler 100 may comprise housing unit 110, a photography unit 120, a sample-preparation unit 130, a network connector 150 and a power 140 connection.

According to embodiments of the invention as illustrated in FIG. 2, housing unit 110 may provide housing for inserting sample strip 115 through an opening 112 and holding sample strip 115 while the sample is prepared and photographed.

According to embodiments of the invention as illustrated in FIG. 2, preparation unit 130 may prepare the sample for photography, by smearing the sample—to provide a large surface for photographing; drying the sample and staining the sample.

According to embodiments of the invention as illustrated in FIG. 2, photography unit 120 may include a photographing device such as a digital stills camera, a digital video camera, a solid state detector for visible light waves (such as a solid-state Charged Coupled Device known as a CCD camera) and the like. Photography unit 120 may enable storing and transmitting the photographed sample image to Analysis unit 200.

According to embodiments of the invention as illustrated in FIG. 2, connector 150 may be any device that allows transmission of data to transmission unit 500, such as a Universal Serial Bus (USB) connector, a Video Graphic Array (VGA) connector, and the like. Connector 150 may include cablings, and may be directly connected to photography unit 120 at one end and to transmission unit 500 at the other end.

According to embodiments of the invention as illustrated in FIG. 2, power 140 may be any connection to any power source such as an Alternative Currant (AC) electric source, a battery and the like.

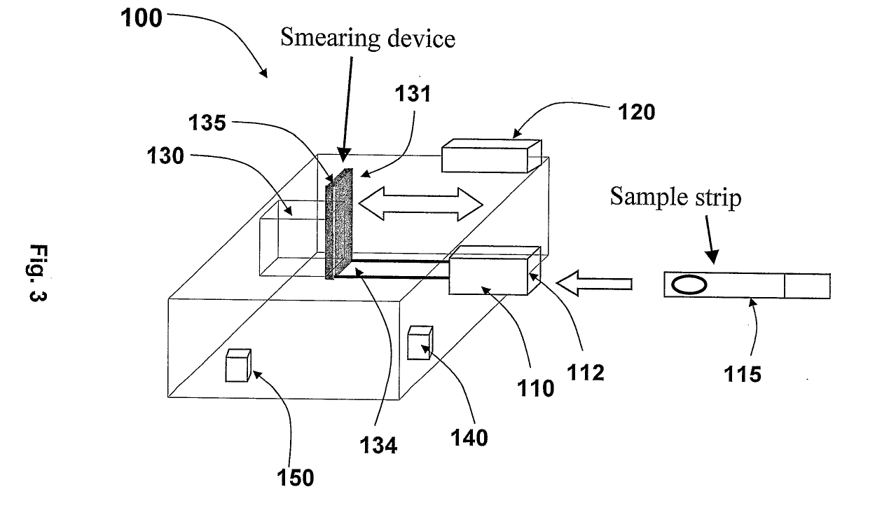

FIG. 3 schematically illustrates a smearing device 131 of sample-preparation unit 130, according to some embodiments of the present invention. To smear the sample-smearing device 131 is installed within sampler 100. Smearing device may include at least one smearing piece 135 and a smearing base 134. Sample strip 115 may be placed on base 134 through housing unit 110, where the blood sample itself faces upwards. Smearing piece 135 may then be moved manually or automatically, in a substantially horizontal direction across the sample at least one time, to smear the sample into a flattened shape that will increase the surface of the sample.

Drying the sample may be carried out through an air opening threaded at sampler 100, by a fan, a combination of a fan and an air opening or any other drying mechanism, according to embodiments of the invention.

Sampler 100 may automatically carry out all smearing, drying and staining of the sample, once sample strip 115 is inserted into opening 112, according to embodiments of the present invention. For example, patient, 10 may insert sample strip 115 and the sample will be automatically prepared and photographed by sampler 100.

According to embodiments of the present invention, some parts of sampler 100 may be removable to allow replacement of all parts that come in contact with the sample. For example, smearing piece 135, the staining device and parts of housing unit 110 may be removable. The removable parts may be designed and packaged as a kit that may be placed in sampler 100, For example, a drawer-like kit that comes in hygienically sealed packages that can be inserted into a drawer-like opening in sampler 100, where the kit is designed to install all the kit's parts in their right place in sampler 100.

According to embodiments of the present invention, sampler 100 may include operation buttons that may provide patient 10 control over different stages of sampler 100. For example, “on” and “off” button that connects and disconnects sampler's 100 power 140 supply; a smearing button that provides control over number of smearing moves of smearing piece 135, a photo button that controls the photography option and the like. Sampler 100 may further include indicators that indicate whether the sample is prepared and patient 10 can press the photographing button, for example.

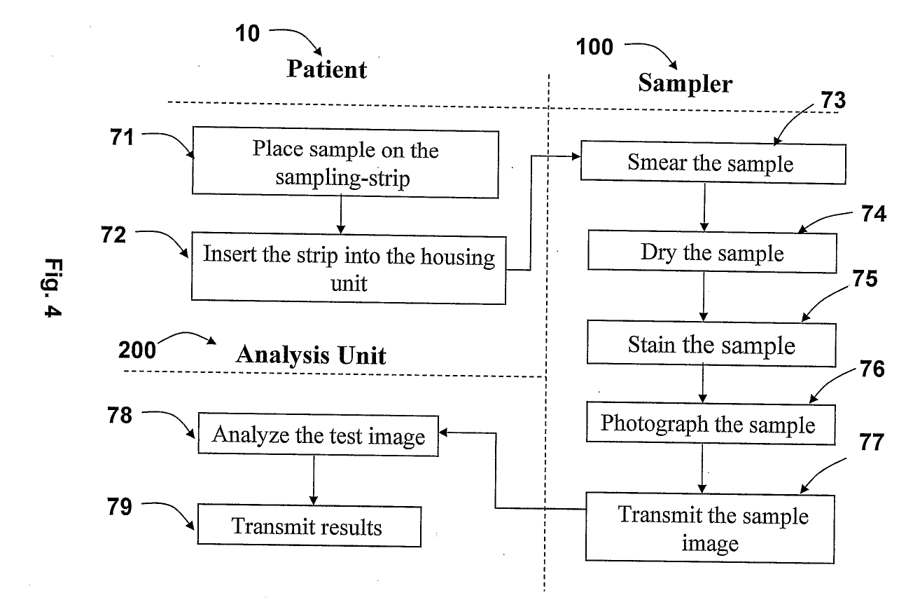

FIG. 4 schematically illustrates a method for blood sampling and sample-analysis using sampler 100, transmission unit 500, and analysis unit 200, according to some embodiments of the present invention. The method comprises the steps of:
placing the sample on a sampling strip 71, where the sample is at least one drop of blood that has been taken by patient 10;
inserting the strip into the housing unit 72;
smearing the sample 73, wherein a smearing device that is installed within the sampler smears down the sample;
drying the sample 74, wherein the sample is placed facing an air opening for a predetermined period of time to allow it to dry or any other drying device;
staining the sample 75, wherein the sample is stained by a staining device that is installed within sampler 100;
photographing the sample 76 by photography unit 120;
transmitting the patient's related information and the sample image 77 that was photographed by photography unit 120, wherein sampler 100 transmits the data to analysis unit 200 through transmitting unit 500;
analyzing the sample image 78, wherein analysis unit 200 analyzes the image transmitted to it by sampler 100.
   Analysis unit 200 may transmit the results to patient 10 and to medical authority 20 for further analysis, where patient 10 and medical authority 20 may use any type of communication and network devices to receive the results, such as a cellular phone with a network connection, a computer, a laptop.

According to embodiments of the present invention, for urine samples, the above description of the method may not include the step of smearing the sample. Sampler 100 may be modified to suit urine sample preparation and not include the smearing device.

According to embodiments of the present invention, the results may be transmitted through a message that may be, for example an Email message, a Short Messages Service (SMS) message, Multimedia Messaging Service (MMS) message and the like.

According to embodiments of the present invention, photography unit 120 may be external to sampler 100. For example, photographing the sample may be carried out through a cellular phone that includes a camera, where the cellular phone may be used as both photography unit 120 and transmission unit 500.

According to other embodiments of the present invention, transmission unit 500 may be integrated into sampler 100, where the sampler 100 may allow transmission of the sample image and related patient's information. Additionally to this embodiment, sampler 100 may further include a receiver unit that may allow sampler 100 to encompass more functions of the process, where sampler 100 automatically prepares the sample, photograph the sample, transmits the sample image and receives the analysis results. The receiver unit may include, for example, a receiver and a screen, to allow presentation of visual or textual messages.

According to embodiments of the present invention, Analysis unit 200 may be integrated in sampler 100. The analysis of the sample image may be carried out, for example, on-chip, where the chip is installed within sampler 100. The resulting analysis may be automatically transmitted to patient 10 and to medical authority 20.

While the invention has been described with respect to a limited number of embodiments, these should not be construed as limitations on the scope of the invention, but rather as exemplifications of some of the preferred embodiments. Those skilled in the art will envision other possible variations, modifications, and applications that are within the scope of the invention. Accordingly, the scope of the invention should not be limited by what has thus far been described, but by the appended claims and their legal equivalents.

1. A system for sampling and sample-analysis that enables a patient to conduct a personal sampling, said system comprises:
a sampler device that comprises a housing unit, a sample-preparation unit and a photography unit, where the sampler enables network communication through at least one network connector and a power source connection, wherein the photography unit provides a digital image of the prepared sample;
a transmission unit that allows transmission of sampling data and patient's related information through a communication network; and
an analysis unit that carries out automatic computerized analysis of the sampling outputting an analysis result,
wherein the results of said analysis unit are transmitted to the patient and to a medical authority for further medical analysis and decision making and
wherein said sample preparation unit comprises a smearing device and a staining device, respectively enabling smearing and staining of the sample preparing said sample to be photographed by said photography unit.

2. The system of claim 1, wherein the sample is a blood sample taken by the patient, and wherein said staining and smearing of said blood sample allows blood count related analysis.

3. The system of claim 1, wherein the housing unit includes an opening for inserting the sample strip, where the housing unit holds the sample strip while the sample is being prepared and photographed by the sampler.

4. The system of claim 1 farther enables sampling and sample analysis of the patient's urine sample, by placing urine drops on the sample strip, wherein said staining and smearing of said sample allows cell count related analysis.

5. (canceled)

6. The system of claim 1, wherein the sampler automatically operates the smearing, the staining and the drying devices, once the sample strip is inserted into the housing unit.

7. The system of claim 1, wherein the smearing device comprises a smearing piece and a smearing base where the sample strip is placed on the said base and the smearing piece passes through the sample at least once and smears it.

8. The system of claim 1, wherein the preparation unit further comprises a drying device enabling drying of the sample, once said sample has been stained.

9. The system of claim 1, wherein the transmission device is a cellular phone that provides wireless network communication and the connector enables data transmission to at least one type of cellular phone.

10. The system of claim 1, wherein the transmission device is a computer that provides an internet network communication and the connector enables data transmission to a computer.

11. The system of claim 1, wherein the photography unit includes at least one camera and, wherein said camera further enables transmission of the photographed image of the sample.

12. The system of claim 10, wherein the camera is a solid-state detector that enables detection of sample images.

13. The system of claim 1, wherein the photography unit includes a camera and enables automatic transmission of the photographed image to the analysis unit.

14. The system of claim 1, wherein the analysis unit is a software application comprising at least one image processing algorithm.

15. The system of claim 13, wherein the said software application is seated at a remote computerized unit.

16. The system of claim 1, wherein the analysis unit is seated within the sampler device.

17. The system of claim 1, wherein the analysis is carried out through a processor enabling storing and analyzing the sample image.

18. The system of claim 16, wherein the processor is seated within the sampler device to allow automatic results outputting, presentation and transmission of the said results to the patient and to the medical authority.

19. The system of claim 1, wherein the transmission unit is integrated within the sampler.

20. A sampler that is a self testing device that enables photographing a sample that is placed on a sample strip by a patient, where the said sample is automatically prepared and photographed, said sampler comprises:
a housing unit—for placing and holding the sample strip,
a sample-preparation unit—for preparing the sample to be photographed,
a photography unit—to photograph the sample and allow digital storage of the sample image,
a connector that may allow connection to a communication network
and a power connection to allow connection to a power source;
wherein the sample-preparation unit prepares the sample by smearing, drying and staining of the sample.

21. The sampler of claim 19, wherein the sampler automatically operates the smearing, the staining and the drying devices, once the sample strip is inserted into the housing unit.

22. The sampler of claim 19 wherein the smearing device comprises a smearing piece and a smearing base where the sample strip is placed on the said base and the smearing piece passes through the sample at least once and smears it.

23. The sampler of claim 19 further includes a transmission unit that allows transmission of the photographed sample image to a remote analysis unit for image analysis.

24. The sampler of claim 22 further includes a receiver unit that enables receiving and representation of the analysis results.

25. The sampler of claim 23, wherein the receiver unit further includes a screen to allow representation of analysis results.

26. The sampler of claim 19, wherein the photography unit is a cellular phone that enables photographing of the sample and transmitting the sample image and the patient's related information to the analysis unit.

27. The sampler of claim 19, wherein the analysis unit is seated in the sampler as an integrated part of the sampler.

28. A method for sampling and sample-analysis that enables a patient to conduct a personal sampling using a sampler device that comprises a power connection, a housing unit, a sample-preparation unit, a photography unit and a network connector, said method comprises the steps of:
placing the sample on a sampling strip, where the sample has been taken by the patient;
inserting the strip into the housing unit of the sampler;
preparing the sample, using the preparation unit;
photographing the sample by the photography unit;
transmitting the patient's related information and the sample image that was photographed by the photography unit, wherein the sampler transmits the data to the analysis unit through the transmitting unit;
analyzing the sample image, wherein the analysis unit analyzes the image transmitted to it by the sampler; and
transmitting the results of the analysis, wherein the analysis unit transmits the said results to the patient and to a medical authority for further analysis.

29. The method of claim 27, wherein preparing the sample is carried out through the steps of smearing the sample, drying the sample and staining the sample—respectively, wherein the smearing, drying and staining of the sample is carried out in the preparation unit that is installed within the sampler.

30. The method of claim 27, wherein the analysis unit is a computerized unit that enables image processing of the sample image through at least one algorithm.

31. The method of claim 27, wherein the smearing device in the sampler comprises a smearing piece and a smearing base, where the sample strip is held by the said base and the said piece moves horizontally over the base to allow the smearing of the sample.

32. The method of claim 27, wherein the drying of the sample is made by a fan that is integrated within the sampler and the sample-preparation unit.

33. The system of claim 1, wherein the sample is taken by the patient and wherein said staining and smearing of said sample allows cell count related analysis.
